(19) United States
(12) Patent Application Publication
(10) Pub. No.: US 2006/0000364 A1
(43) Pub. Date: Jan. 5, 2006

(54) Coffee machine with creme production facility

(75) Inventors: Man Lung Lau, Hong Kong SAR (CN); Ping Chu, Hong Kong SAR (CN)

Correspondence Address: ALIX YALE & RISTAS LLP, 750 MAIN STREET, SUITE 1400, HARTFORD, CT, 06103, US

(73) Assignee: Chiaphua Industries Limited

(21) Appl. No.: 10/882,706

(22) Filed: Jul. 1, 2004

(51) Int. Cl. A23F 3/00

(52) U.S. Cl. 99/295

(57) ABSTRACT

A coffee-making machine includes: a nozzle from which an airborne stream of liquid containing coffee extract is ejected under pressure, a funnel downstream of the nozzle for receiving the ejected coffee extract and draining it substantially without retention, and a frothing member positioned in or upstream of the funnel and against which the airborne stream of liquid from the nozzle impinges directly and by which air is entrained in the liquid.

### BACKGROUND OF THE INVENTION

The present invention relates to coffee brewing machines. More particularly, although not exclusively, the invention relates to a domestic appliance capable of producing a hot liquid coffee beverage having a layer of fine bubbles or coffee crème at its surface.

Many coffee drinkers enjoy coffee having a layer of coffee crème at the liquid surface. This is a layer of fine bubbled froth produced by the coffee extract in hot water. This is to be distinguished from frothed milk as might be applied to café latte or cappuccino for example. Coffee beverages purchased from commercial establishments usually have a crème layer and this is perceived as an indication of a high quality coffee.

It is very difficult to achieve a crème layer when brewing one's own coffee at home or in the office without use of expensive commercial equipment.

### OBJECTS OF THE INVENTION

It is an object of the present invention to overcome or substantially ameliorate the above disadvantage and/or more generally to provide an improved coffee machine with a crème production facility.

### DISCLOSURE OF THE INVENTION

There is disclosed herein a coffee-making machine, comprising:

a nozzle from which an airborne stream of liquid containing coffee extract is ejected under pressure,

a funnel downstream of the nozzle for receiving the ejected coffee extract and draining it substantially without retention, and

a frothing member positioned in or upstream of the funnel and against which the airborne stream of liquid from the nozzle impinges directly and by which air is entrained in the liquid.

Preferably, the coffee-making machine further comprises a spout that extends from the funnel and through which the liquid is dispensed.

Preferably, the coffee-making machine further comprises a chamber upstream of the nozzle and into which a ground coffee-containing pouch is received.

Preferably, the frothing member comprises a plate having an aperture therethrough.

Alternatively, the frothing member comprises a plate having a plurality of apertures therethrough.

Preferably, the frothing member in attached to or formed integrally with the funnel.

Preferably, the frothing member is detachable from the funnel.

Preferably, the plate extends normally to the stream of liquid ejected by the nozzle.

There is further disclosed herein a coffee-making machine, comprising:

a nozzle through which a stream of liquid containing coffee extract is ejected under pressure, the nozzle having an air-entry aperture through which air enters the nozzle to mix with the stream of liquid as it passes through the nozzle.

### BRIEF DESCRIPTION OF THE DRAWINGS

Preferred forms of the present invention will now be described by way of example with reference to the accompanying drawings, wherein:

FIG. 1 which is a schematic cross-sectional elevation of the key components of a coffee-making machine that are relevant for the production of a coffee crème layer in a cup of coffee produced by the machine, and

FIG. 2 is a schematic cross-sectional elevation of an alternative apparatus for the production of a coffee crème layer.

### DESCRIPTION OF THE PREFERRED EMBODIMENTS

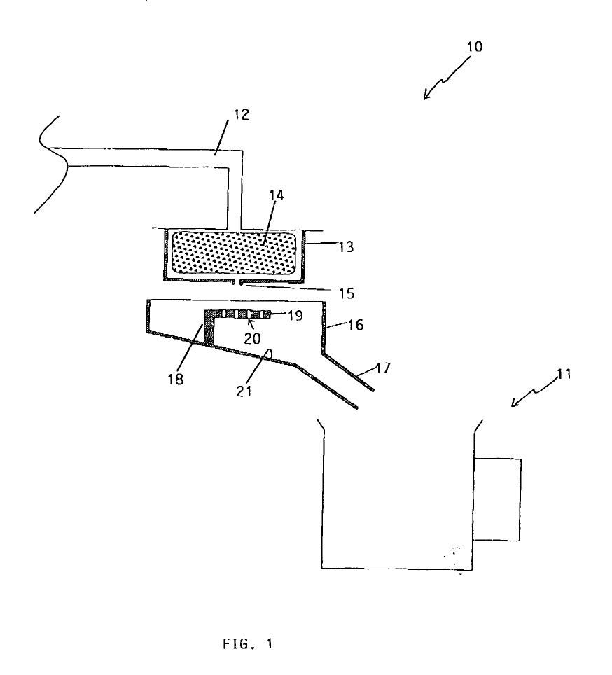

In FIG. 1 of the accompanying drawing there is depicted schematically a coffee-making machine 10 and a cup 11 to which the coffee beverage is to be dispensed. Many components of the machine are not depicted in the drawing because they are known in the art. Some of these features include a liquid reservoir, a heater for heating water from the reservoir and an electric pump for pumping the water under pressure to a delivery line 12.

The delivery line 12 delivers hot pressurised water to a sealed chamber 13 in which a paper-encased ground coffee pouch 14 is received. A closure mechanism (not shown) seals the chamber 13.

In the bottom of the chamber there is provided a small nozzle 15 from which coffee extract-containing heated water is ejected downwardly in a vertical stream. This stream is directed into a space containing air, hence the stream can be said to be “airborne”. The nozzle is small in diameter (typically about 0.8 mm) and serves two fundamental functions. The first function is to produce the high-velocity liquid jet and the second function is to regulate the flow rate of water through the chamber 13. This obviates the requirement for a mechanical or optical flow-metering device in or upstream of the delivery line 12 to deactivate the pump when the cup 11 is anticipated to be full. In the present embodiment, a simple digital timer deactivates the pump when the cup is near-full.

Situated beneath the chamber 13 is a funnel 16 having an outlet spout 17 via which the coffee beverage is dispensed to the cup 11.

Located within the funnel 16 and surrounded by air is a frothing member 18 that extends upwardly from the floor 21 of the funnel 16. In the depicted embodiment, the frothing member comprises a flat horizontal plate 19 having a plurality of vertical apertures 20 therethrough. The frothing member might be moulded integrally with the funnel 16, or manufactured as a separate attachment. Manufacturing the frothing member as a separate attachment simplifies moulding of the combined funnel and frothing member. Also, if the frothing member is detachable from the funnel 16 it can be easily removed for cleaning, or removed by users who do not wish to make coffee with a crème layer. To facilitate removal, the frothing member might slot into the funnel 16, or be attached thereto by screws or other fastening devices.

In use, heated water is pumped via the delivery line 12 through the chamber 13 whereupon coffee extract from the ground coffee beans within the pouch 14 forms a liquid jet upon passing from the nozzle 15. This liquid jet passes through the airspace and impinges forcefully and downwardly upon the plate 19 of the frothing member 18. Some of the liquid jet will be forced through at least one of the vertical apertures 20 and some of the liquid jet will deflect from the upper surface of the plate 19 and fall into the funnel 16. The frothing member will never be submerged as the funnel is designed to pass liquid immediately to the cup without retaining it. The upper opening of the funnel is sealed and therefore any splashes of liquid will not escape through the top of the funnel to the surrounding bench space. The liquid jet undergoes significant turbulence and sheer forces as it encounters the frothing member. This results in the formation of fine bubbles which are then carried away with the flow of liquid across the floor 21 of the funnel 16 and then through the spout 17 to the cup 11 to thereby create a coffee crème layer upon the coffee in the cup 11.

The frothing member would typically be made of hard plastics material, stainless steel or brass for example.

It could be formed as a moulding, casting or pressing, or might be in the form of a single- or multiple-layered mesh.

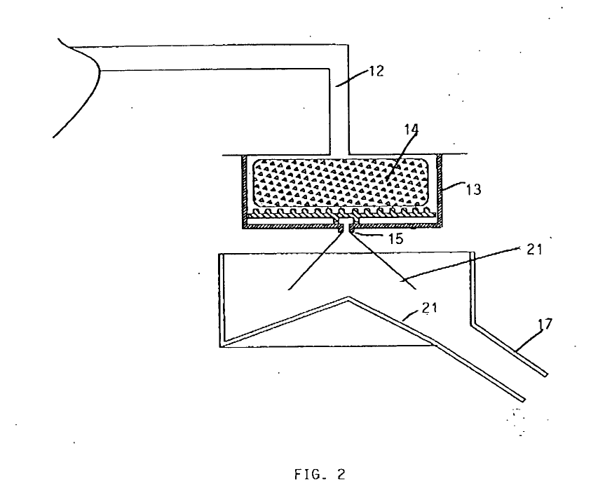

In FIG. 2 there is depicted an alternative embodiment which does not rely upon a frothing member against which the airborne stream of liquid from the nozzle impinges. Instead, the nozzle 15 is formed as a spray head having a small aperture. When the coffee extract exits the nozzle 15 it forms a fine spray 21 which then forms a foam layer upon the floor 21 of the funnel and then flows under gravity through the spout 17 for dispensation to form a crème.

It should be appreciated that modifications and alterations obvious to those skilled in the art are not to be considered as beyond the scope of the present invention. For example, rather than being a fixed structure, the frothing member might be made movable, such as for example by being rotatably mounted upon an axle, or resiliently mounted upon a spring. Furthermore, instead of being attached to the funnel, the frothing member might depend from the bottom surface of the pressure chamber. It might even be formed integrally with the nozzle.

1. A coffee-making machine, comprising:
a nozzle from which an airborne stream of liquid containing coffee extract is ejected under pressure,
a funnel downstream of the nozzle for receiving the ejected coffee extract and draining it substantially without retention, and
a frothing member positioned in or upstream of the funnel and against which the airborne stream of liquid from the nozzle impinges directly and by which air is entrained in the liquid.

2. The coffee-making machine of claim 1, further comprising a spout that extends from the funnel and through which the liquid is dispensed.

3. The coffee-making machine of claim 1, further comprising a chamber upstream of the nozzle and into which a ground coffee-containing pouch is received.

4. The coffee-making machine of claim 1, wherein the frothing member comprises a plate having an aperture therethrough.

5. The coffee-making machine of claim 1, wherein the frothing member comprises a plate having a plurality of apertures therethrough.

6. The coffee-making machine of claim 2, wherein the frothing member is attached to or formed integrally with the funnel.

7. The coffee-making machine of claim 6, wherein the frothing member is detachable from the funnel.

8. The coffee-making machine of claim 4, wherein the plate extends normally to the stream of liquid ejected by the nozzle.

9. A coffee-making machine, comprising:
a nozzle through which a stream of liquid containing coffee extract is ejected under pressure, the nozzle having an air-entry aperture through which air enters the nozzle to mix with the stream of liquid as it passes through the nozzle.
